(19) United States
(12) Patent Application Publication
(10) Pub. No.: US 2024/0356151 A1
(43) Pub. Date: Oct. 24, 2024

(54) Vent Manifold System for a Lithium-Ion Aircraft Battery

(71) Applicant: Textron Aviation Inc., Wichita, KS (US)

(72) Inventors: Brandon Stuart Henderson, Wichita, KS (US); Vernon Weng-Yew Chang, Wichita, KS (US); Michael Louis Koonce, Wichita, KS (US)

(21) Appl. No.: 18/638,428

(22) Filed: Apr. 17, 2024

Related U.S. Application Data
(60) Provisional application No. 63/496,789, filed on Apr. 18, 2023.

(51) Int. Cl. H01M 50/358; H01M 10/0525; H01M 50/112; H01M 50/249; H01M 50/375

(52) U.S. Cl. CPC H01M 50/358; H01M 10/0525; H01M 50/112; H01M 50/249; H01M 50/375; H01M 2220/20

(57) ABSTRACT

A battery module system includes one or more monoblocks each having one or more cells and a ventilation chamber configured to contain gases vented by the one or more cells. The system includes a channel having an exhaust vent that is in flow communication with each of the one or more monoblocks. A seal is positioned between each ventilation chamber of the one or more monoblocks and the channel and is actuatable when a threshold is achieved in the ventilation chamber associated with the seal.

### CROSS-REFERENCE TO RELATED APPLICATIONS

This application claims the benefit of priority of U.S. Provisional Patent Application No. 63/496,789, entitled “Vent Manifold System for a Lithium-Ion Aircraft Battery,” and filed on Apr. 18, 2023, the disclosure of which is herein incorporated by reference in its entirety.

### BACKGROUND

### 1. Field

Embodiments of the invention relate generally to aircraft battery modules, and more specifically to a battery module having a vent manifold system for safely exhausting a lithium-ion aircraft battery.

### 2. Related Art

Various solutions have been proposed for lithium-ion battery ventilation systems. For example, U.S. Pat. No. 8,999,538 of Fuhr et al. discloses a battery module with a sealed vent chamber that includes a plurality of sockets that each receive one of a plurality of electrochemical cells such that the vents of the electrochemical cells are positioned in the chamber. U.S. Pat. No. 9,331,318 of Wood et al. discloses a battery module having a central chamber configured to receive gases released from vents of electrochemical cells positioned such that the vents of a first set of electrochemical cells face the vents of a second set of electrochemical cells which face the central chamber. The central chamber is located between the first set of electrochemical cells and the second set of electrochemical cells. PCT Application Publication WO 2022/003716 of Tushar et al. discloses an exhaust system of a battery module having a first duct member positioned exterior to a surface of a battery pack that includes a plurality of cells and at least two second duct members removably engaged with the first duct member to form the gas holding chamber. U.S. Patent Application Publication No. 2022/0131219 of Anandarajah et al. discloses battery pack structures and systems that include battery cells disposed along a longitudinal beam that provides structural integrity to the battery pack and protection to the battery terminals and couplings.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

In an embodiment of the invention, a battery module system configured to contain a plurality of cells comprises one or more monoblocks that are thermally insulated. Each monoblock includes one or more of the plurality of cells and a ventilation chamber that may be sealed and configured to contain and/or isolate gases vented by the one or more cells within the ventilation chamber. A channel or manifold is coupled to the one or more monoblocks and is in flow communication with the ventilation chamber of each of the one or more monoblocks. The channel exhausts gases vented by the one or more cells of the one or more monoblocks to the environment.

In an embodiment, a first seal is positioned between each ventilation chamber of the one or more monoblocks and the channel. Each seal is independently actuatable when a threshold pressure is reached within the ventilation chamber associated with the seal and/or when a threshold temperature is reached within the ventilation chamber associated with the seal. When each seal is actuated, the channel receives gases from the ventilation chamber of the respective monoblock associated with the actuated seal, and the gases in the channel are exhausted from the exhaust vent extending therefrom.

In an embodiment, the channel includes an exhaust vent to exhaust the gases vented from the one or more monoblocks to an environment. The channel may be a structural member configured for securing the one or more monoblocks to a retainer that contains the one or more monoblocks and/or to a structural frame, such as that of an aircraft. A baffle may be coupled to the channel and may be configured for securing the one or more monoblocks.

In an embodiment, the battery module system includes a retainer for containing the one or more monoblocks. The one or more monoblocks are contained in the retainer and are in engagement with the retainer such that the one or more cells of each monoblock are electrically coupled to the retainer. The retainer may include connections for operation of the battery module system.

In an embodiment, the ventilation chamber of each of the one or more monoblocks includes a cell retaining structure configured to support the one or more cells therein and to position and electrically connect the one or more cells to the retainer that supports the one or more monoblocks.

In an embodiment, the ventilation chamber is configured such that a vent of each of the one or more cells is directed to an egress section in the ventilation chamber.

### BRIEF DESCRIPTION OF THE DRAWING FIGURES

Embodiments of the invention are described in detail below with reference to the attached drawing figures, wherein:

FIG. 1 illustrates a perspective view of a vent manifold system configured for containing lithium-ion battery cells, the cells are contained in three monoblocks and the monoblocks are coupled to a vent manifold for venting gases from the cells to the environment and are secured to a structural retainer, in an embodiment;

FIG. 2 illustrates a perspective view of the battery module system shown in FIG. 1, including the vent manifold coupled to fasteners and connections for monitoring and operating the battery module system coupled to a terminal wall of the structural retainer, in an embodiment;

FIG. 3 is a schematic of the vent manifold system taken along line 2-2 in FIG. 1, including the three monoblocks and the vent manifold, without the structural retainer, in an embodiment;

FIG. 4 illustrates a cross sectional view of one monoblock of the vent manifold system shown in FIG. 1, including the cells secured in a cell retaining structure, in an embodiment; and

FIG. 5 illustrates a cross sectional, section view of an alternative embodiment of a battery module system that includes a single monoblock, the section view includes a cell secured in a cell retaining structure, a rupture disk, and an exhaust vent extending from a baffle that secures the single monoblock with fasteners, in an embodiment.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

Lithium-ion battery cells on aircrafts may be used to provide power to various aircraft systems, as well as provide an auxiliary and/or backup source of power. The cells may provide high energy density, require low maintenance, and minimize downtime due to fast charging.

Despite advantages associated with lithium-ion battery cells, the cells may generate heat and dangerous effluent gases (e.g., toxic hydrogen fluoride gases) that are produced during exothermic chemical reactions within the cells, such as during electrochemical decomposition of the battery cell electrolyte, short circuits between the cells, and/or short circuits within the cells. The cells are susceptible to overheating that may lead to accelerated degradation of the cells, thermal runaway, or even combustion. To avoid overheating, the cells may include safety vents to vent or release the gases that build up within the cells, and gases vented by the cells within a battery module may be exhausted to prevent increases in pressure and temperature.

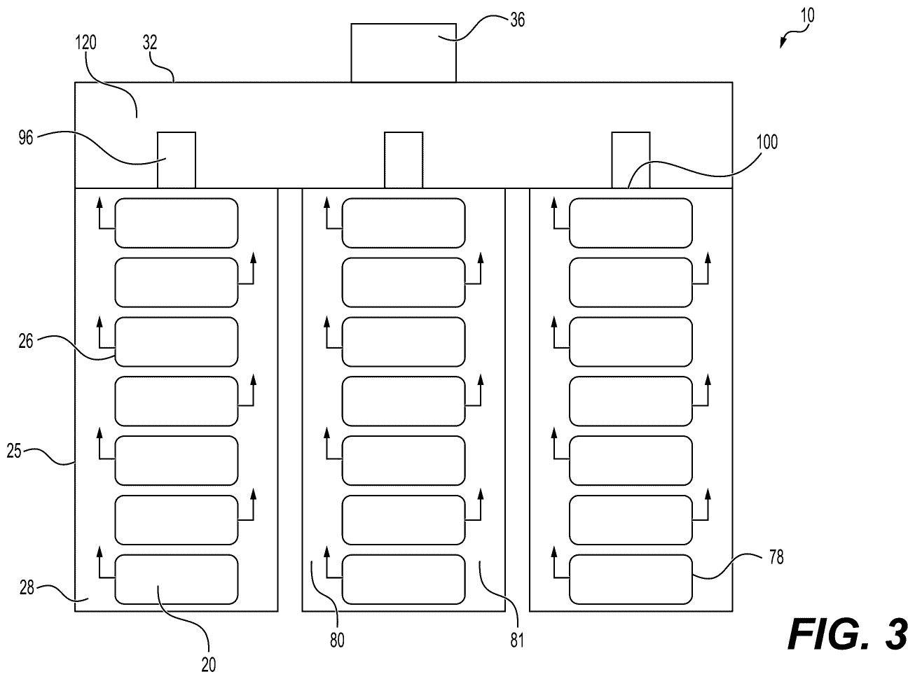

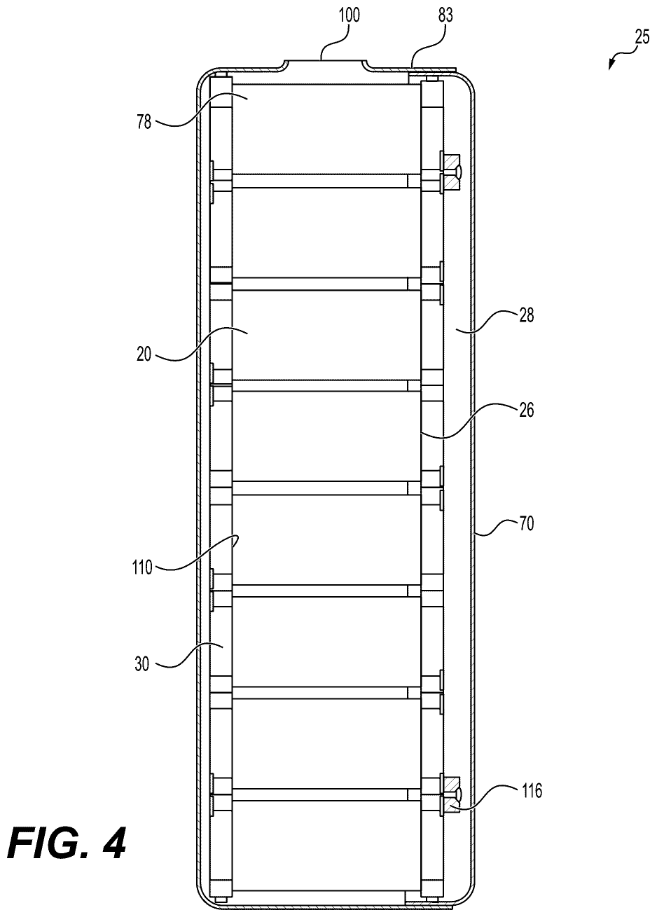

Embodiments disclosed herein provide a battery module system or vent manifold system 10 configured to contain a plurality of lithium-ion battery cells or electrochemical cells 20 (see FIG. 3) in one or more sealed battery cell monoblock modules or monoblocks 25 and exhaust any gas (e.g., hydrogen fluoride gas) produced therein. The cells 20 each include a vent 26 at an end or top section thereof. Each monoblock 25 includes a ventilation cavity or chamber 28 within the monoblock 25 comprising a cell retaining structure or a plurality of receptacles 30 (FIG. 4) configured to receive the cells 20 such that at least the vents 26 of the cells 20 are positioned to vent the gases within the chamber 28. The chamber 28 is configured to contain or isolate gases vented by the cells 20 within each monoblock 25 and release the gases in each monoblock 25 to a channel or gas collection or vent manifold 32 shared between the one or more monoblocks 25. The collection manifold 32 extends over and across and is in flow communication with each of the one or more monoblocks 25 and configured to exhaust the gases from the monoblocks 25 through an exhaust vent 36 to the environment or exterior of the battery module system 10. The exhaust vent 36 may have a one-way seal associated therewith. The collection manifold 32 is also configured to provide a structural member for securing the one or more monoblocks 25 within a structural retainer 38.

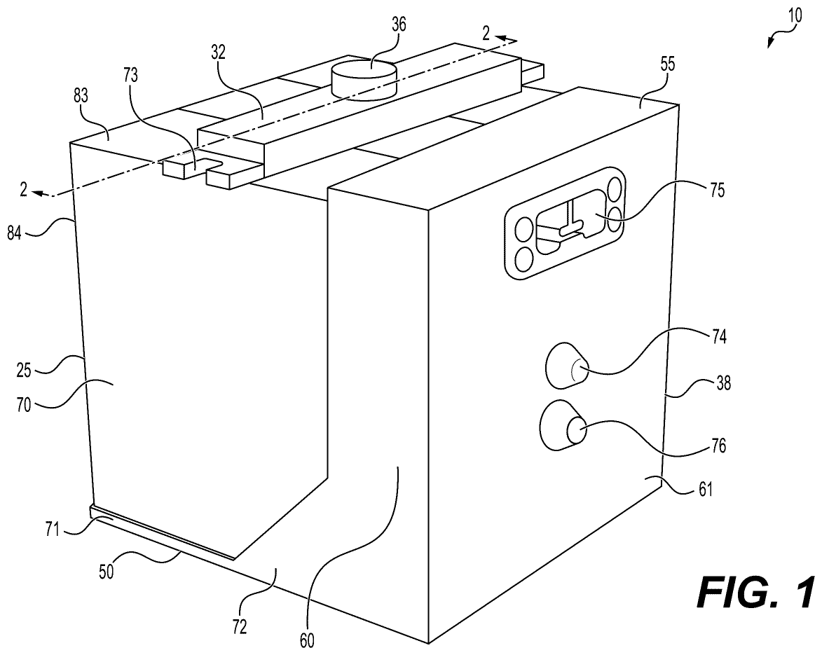

FIG. 1 illustrates a perspective view of the battery module system 10 as per an embodiment of the present invention. The battery module system 10 provides a common structural anchoring system for one or more monoblocks 25, reduces the number of parts used to exhaust gases from the system 10, reduces the weight associated with the system 10 to improve overall performance of the aircraft, and provides partitioning between groups of cells 20, such as for isolation of thermal runaway activity.

As shown, the battery module system 10 includes a structural retainer 38 that retains or secures one or more monoblocks 25. The structural retainer 38 may include a base 50 on which the monoblocks 25 are positioned and wall members, including an upper wall 55 that is parallel to the base 50, side walls 60, and a terminal wall 61. In a preferred embodiment, the base 50 is formed to support the monoblocks 25 that are positioned with adjacent lateral walls 70 abutting on the base 50. The base 50 may include a lip 71 to contain the monoblocks in the structural retainer 38 and/or to secure the manifold 32 thereto. The upper wall 55 extends between vertically extending side walls 60. The terminal wall 61 extends at an end of the monoblocks 25, between the base 50, the top wall 55 and the side walls 60.

As shown in FIG. 1, the monoblocks 25 are positioned in the structural retainer 38 such that each monoblock 25 is in engagement with the terminal wall 61. The terminal wall 61 is formed such that an internal width of the structural retainer 38 is approximately the width of the one or more monoblocks 25 positioned in the structural retainer 38 and the internal height of the structural retainer 38 is approximately the height of the monoblocks 25. Each monoblock 25 extends lengthwise in the structural retainer 38 from the terminal wall 61 to the opposite end of the base 50. In one embodiment, the sidewalls 60 are structural members that provide support for the monoblocks 25. The side walls 60 of the retainer 38 may not extend to cover the entire lateral wall 70 of the monoblock 25 positioned lengthwise on the structural retainer 38. In one embodiment, the side walls 60 are formed to extend from the terminal wall 61 along the lateral wall 70 of the monoblock 25 to cover approximately one-third of the length of the lateral wall 70 of the monoblock 25. In another embodiment, the side walls 60 are formed to cover approximately one-fourth of the length of the lateral wall 70 of the monoblock 25. In yet another embodiment, the side walls 60 are formed to cover less than one-fifth of the length of the lateral wall 70 of the monoblock. The upper wall 55 extending therebetween has a similar dimension to the width of the side walls 60 to which it is coupled. A bracket or an angled section 72 may extend from the side wall 60 to the base 50 to further support the one or more monoblocks 25 within the structural retainer 38.

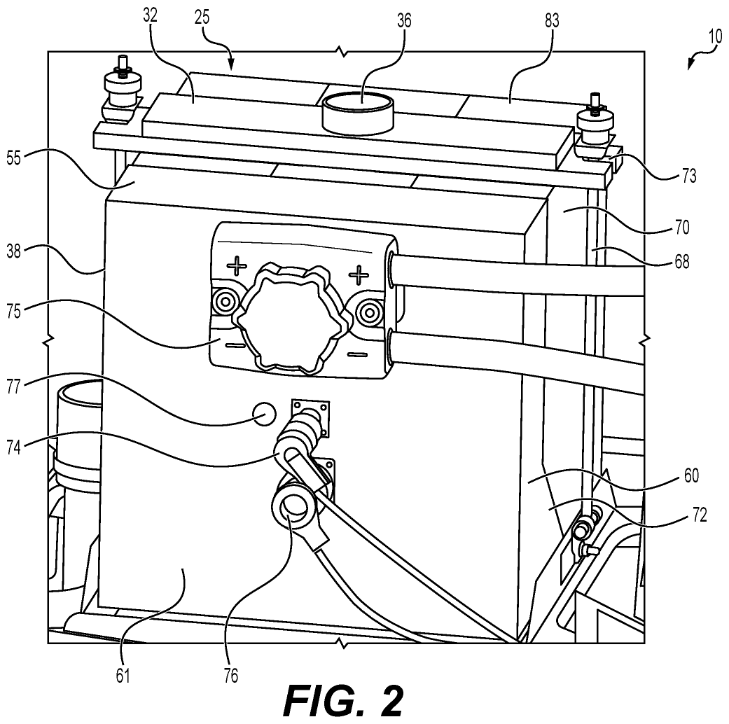

The collection manifold 32 is also configured to double as a structural member that may be used for securing the one or more monoblocks 25 within the structural retainer 38 or securing the battery module system 10 to the aircraft. For example, as shown in FIG. 2 the collection manifold 32 may comprise a recess 73 at each end configured for receiving fasteners 68 (e.g., tie rods or straps) for fastening the collection manifold 32 to the base 50 or applying a restraining force to secure the battery module system 10 to the aircraft. Other means of fastening the collection manifold 32 and thus securing the monoblocks 25 within the open end of the structural retainer 38 or securing the battery module system 10 in the aircraft may be employed without departing from the scope hereof.

As shown in FIG. 2, the terminal wall 61 includes connections for monitoring and operating the battery module system 10. An RTD electrical connection 74 is positioned on the terminal wall 61 and includes a sensor for detecting a temperature. An electrical receptacle connector 75 is configured to mate with a battery disconnect switch (not shown) for manually disconnecting electrical continuity of the battery cells 20, resulting in stopping electrical power from being transferred from the battery cells 20 such as during servicing of the battery module system 10. An aircraft communications electrical connection 76 is configured to be electrically connected to the plurality of cells 20 therein for charging and discharging the battery module system 10 and/or connecting the battery module system 10 to an on-board network. A button 77 is provided to preheat the module system 10 via embedded heaters (not shown).

A battery management system (not shown) is configured to monitor and manage each of the battery cells 20 in the battery module system 10, including providing cell protection management, optimizing performance, and reporting operational conditions to external devices. The battery management system may be integrated into or separated from the battery module system 10. The battery management system may include control electronics such as printed-circuit boards, solid-state relays, an automatic and/or the manual battery disconnect switch, etc. In embodiments, each monoblock 25 comprises an embedded heater for pre-heating cold-soaked battery cells 20.

The lithium-ion battery cells 20 are rechargeable cells that function by transferring lithium ions between an anode (not shown) and a cathode (not shown). Neutral lithium atoms are oxidized in the anode during discharge to produce positively charged lithium ions. In one embodiment, the anode is a lithiated graphite network. The positively charged lithium ions migrate through an electrolyte medium (not shown) to the cathode as the cell provides an electric current. In one embodiment, the cathode is a lithiated metal oxide. The positively charged lithium ion is incorporated into the cathode. To recharge the cell 20, the reaction is reversed. The positively charged lithium ions move from the cathode to the anode and are reduced to neutral lithium atoms and reincorporated into the anode.

The cells 20 each include a casing 78 having at least one negative terminal (not shown), at least one positive terminal (not shown), and a vent 26. The casing 78 contains the anode, the cathode, and the electrolyte therewithin that allows for diffusion of the lithium ions between the anode and the cathode. The negative terminal is conductively coupled to the anode and the positive terminal is conductively coupled to the cathode. In a preferred embodiment, the negative electrode and the positive electrode are positioned on a side of the casing 78 opposite the vent 26.

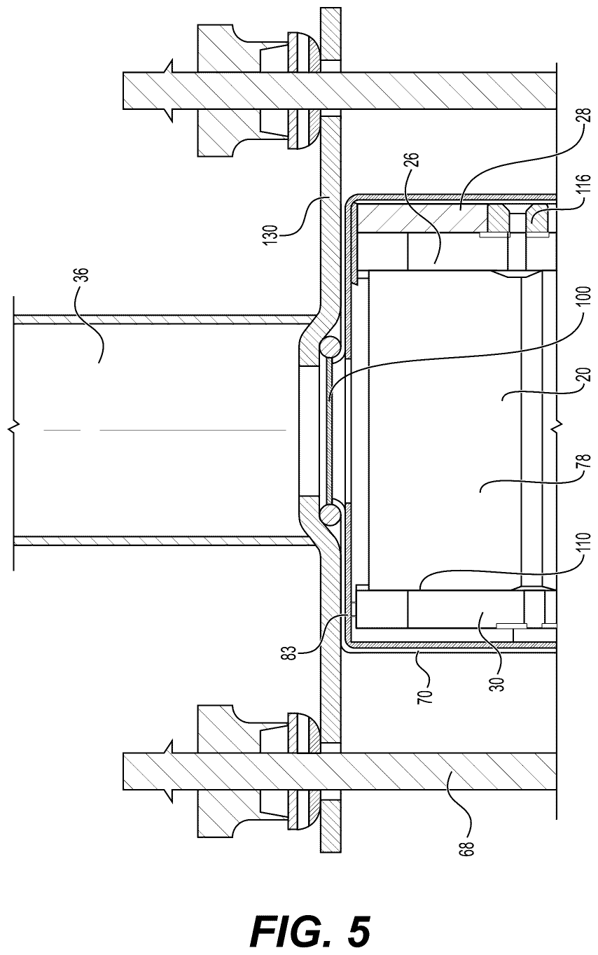

As shown in FIG. 3, each monoblock 25 is configured to contain at least one lithium-ion battery cell 20 within the ventilation chamber 28. Each cell 20 is separately contained in its casing 78 and electrically connected to other cells 20 in the monoblock 25. One or more busbars 116 (FIGS. 4 and 5) for electrical connection may be provided therein. The cells 20 may be connected in series and/or in parallel depending on a power application. The cells 20 are electrically coupled to the battery module system 10. The cells 20 are arranged in the chamber 28 such that the vent 26 of each of the cells 20 is directed within the ventilation chamber 28 in the monoblock 25. In one embodiment, there are two groups of cells 20, each group positioned to vent gases to one of a first egress section 80 and a second egress section 81 of the ventilation chamber 28, which extend along opposite sides of the chamber 28. The egress sections 80 and 81 channel the gases toward the collection manifold 32.

The monoblock 25 comprises exterior side walls, including at least the lower wall or floor (not shown), the side or lateral walls 70, an upper wall 83, and a rear wall 84. In one embodiment, the walls of the monoblock 25 are formed from a fire-resistant and non-conductive material that electrically insulates the cells 20 in the monoblock 25. The exterior side walls of the monoblock 25 are coupled together and the sealed ventilation chamber 28 is formed therein. In one embodiment, the monoblock 25 does not include a front wall and the cells 20 are accessible when the monoblock 25 is removed from the structural retainer 38. In one embodiment, one or more of the walls of the monoblock 25 can be removed to access the cells 20. In one embodiment, each monoblock 25 may be individually removed from structural retainer 38 which allows facile replacement of an individual monoblock 25 (e.g., following degradation, overheating or a thermal runaway event).

In an embodiment of the invention, the ventilation chamber 28 formed in the monoblock 25 is configured to sustain increased pressures and temperatures from the gases vented from the cells 20. In one embodiment, the ventilation chamber 28 includes a sealed lining (e.g., gaskets) to prevent leakage of gases vented from the cells 20. FIG. 4 illustrates a monoblock 25 and its components, excluding insulation that may be included between the cell retaining structure 30 and the housing or walls of the monoblock 25. As shown in FIG. 4, each ventilation chamber 28 includes the cell retaining structure 30 configured to position the cells 20 in the chamber 28 and electrically couple the cells 20 to the battery module system 10, a duct 96 (see FIG. 3) positioned to couple the ventilation chamber 28 to the collection manifold 32 and a seal 100 positioned between the ventilation chamber 28 and the collection manifold 32. The seal 100 may be one or more of a one-way seal, a valve, a rupture disk, or another type of pressure relief device, and each seal is independently actuatable to open or fail due to a pressure and/or temperature of the associated ventilation chamber 28. In an embodiment, the seal 100 is a rupture disk that protects the associated monoblock 25 from over-pressurization, such as when a threshold temperature and/or pressure of the monoblock 25 is achieved or during a thermal runaway event. In the case of when one of the rupture disks 100 fails, the others rupture disks 100 on the other monoblocks 25 are able to remain intact due to exhaustion of gases through the exhaust vent 36. In an embodiment, the cell retaining structure 30 positions the cells 20 away from the other cells 20 and away from the walls of the chamber 28.

In one embodiment, the cell retaining structure 30 is a sealed cavity within the ventilation chamber 28 and includes a plurality of sockets 110 configured to couple to each cell 20 such that the vented gases of each associated cell 20 are received in the ventilation chamber 28 and the cell 20 is contained in the cell retaining structure 30.

In the embodiment shown in FIGS. 1-4, the cells 20 contained in each monoblock 25 vent gases to the ventilation chamber 28 of the respective monoblock 25 and the monoblock 25 isolates the gases of those cells 20. The rupture disk 100 is actuated or ruptured when a predetermined pressure threshold and/or temperature threshold is reached within the ventilation chamber 28 coupled to the rupture disk 100. When the threshold is reached, the rupture disk 100 is configured to allow the gases vented from the cells 20 to be released through the duct 96 into the collection manifold 32, releasing the pressure and/or decreasing the temperature in the chamber 28. The collection manifold 32 is coupled to each of the monoblocks 25 via the independently rupturable rupture disks 100.

The collection manifold 32 is configured to contain the vented gases from the cells 20 from the one or more monoblocks 25 and route the gases to the exhaust vent 36. The collection manifold 32 is sealably coupled to the ducts 96 and extends across the upper walls 83 of the one or more monoblocks 25. In an embodiment, the collection manifold 32 cooperates with the structural retainer 38 to contain the monoblocks 25. In one embodiment, a channel 120 within the collection manifold 32 is configured to route the gases toward the exhaust vent 36. In an embodiment the exhaust vent 36 extends into the outside environment. The exhaust vent 36 may include a valve (not shown) and/or a seal (not shown) between the collection manifold 32 and the exterior environment that may be manually or automatically actuated to release the gases. In one embodiment the recesses 73 of collection manifold 32 may be used to anchor the battery module system 10 in an aircraft and prevent movement of the system 10 therein.

FIG. 5 illustrates an embodiment of the system 10 with a single monoblock 25. The system 10 includes a baffle or collection plate 130 that is joined to the exhaust vent or channel 36, and the rupture disk 100 positioned between the ventilation chamber 28 of the monoblock 25 and the exhaust vent 36. In one embodiment, the baffle 130 and the exhaust vent 36 are connected by welding. Fasteners 68 are secured to the baffle 130 to secure the monoblock 25, such as within the aircraft. The cells 20 contained in the monoblock 25 vent gases to the ventilation chamber 28 of the monoblock 25 and the monoblock 25 isolates the gases of those cells 20. The rupture disk 100 is ruptured when a predetermined pressure threshold and/or temperature threshold is reached within the ventilation chamber 28 coupled to the disk 100. When the threshold is reached, the disk 100 is configured to allow the gases vented from the cells 20 to be released to the channel of the exhaust vent 36, releasing the pressure and/or decreasing the temperature in the chamber 28. The exhaust vent 36 channels or releases the vented gases to the environment, as described herein.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims.

What is claimed is:

1. A battery module system comprising:
one or more monoblocks, each monoblock including one or more cells and a ventilation chamber configured to contain gases vented by the one or more cells;
a channel having an exhaust vent, the channel in flow communication with each of the one or more monoblocks; and
a seal positioned between each ventilation chamber of the one or more monoblocks and the channel, wherein each seal is actuatable when a threshold is achieved in the ventilation chamber associated with the seal.

2. The battery module system of claim 1, wherein the channel is a structural member configured for securing the one or more monoblocks.

3. The battery module system of claim 1, further comprising a baffle coupled to the channel, wherein the baffle is configured for securing the one or more monoblocks.

4. The battery module system of claim 1, further comprising a retainer for containing the one or more monoblocks, wherein the one or more monoblocks are in engagement with the retainer and the retainer includes connections for operation of the battery module system.

5. The battery module system of claim 1, wherein each ventilation chamber includes a cell retaining structure configured to position and electrically connect the one or more cells to a retainer that supports the one or more monoblocks.

6. The battery module system of claim 1, wherein each ventilation chamber is configured such that a vent of each of the one or more cells is directed to an egress section in the ventilation chamber.

7. The battery module system of claim 1, wherein the seal between each ventilation chamber of the one or more monoblocks and the channel is independently actuatable when a threshold pressure is reached within the ventilation chamber or when a threshold temperature is reached within the ventilation chamber.

8. A battery module system comprising:
one or more monoblocks, each monoblock including one or more cells that are retained in a cell retaining structure configured to position and electrically connect the one or more cells to a retainer that supports the one or more monoblocks;
a channel having an exhaust vent, the channel in flow communication with each of the one or more monoblocks;
a seal positioned between each of the one or more monoblocks and the channel, wherein each seal is actuatable when a threshold is achieved in the one or more monoblocks associated with the seal; wherein:
the one or more monoblocks are in electrical engagement with the retainer and the retainer includes connections for operation of the battery module system.

9. The battery module system of claim 8, wherein the channel is a structural member configured for securing the one or more monoblocks.

10. The battery module system of claim 8, further comprising a baffle coupled to the channel, wherein the baffle is configured for securing the one or more monoblocks.

11. The battery module system of claim 8, wherein the one or more monoblocks include a ventilation chamber configured to contain gases vented by the one or more cells.

12. The battery module system of claim 11, wherein a vent of each of the one or more cells is directed to an egress section in the ventilation chamber.

13. The battery module system of claim 11, wherein the seal between each ventilation chamber of the one or more monoblocks and the channel is independently actuatable when a threshold pressure is reached within the ventilation chamber or when a threshold temperature is reached within the ventilation chamber.

14. A battery module system comprising:
one or more monoblocks, each monoblock thermally insulated and including one or more cells supported in a cell retaining structure and a ventilation chamber configured to contain gases vented by the one or more cells;
a channel having an exhaust vent extending therefrom that is configured to exhaust gases vented by the one or more cells to an environment, the channel in independent flow communication with each of the one or more monoblocks;
a seal positioned between each ventilation chamber of the one or more monoblocks and the channel, wherein each seal is actuatable when a threshold is achieved in the ventilation chamber associated with the first seal;
wherein when each seal is actuated, the channel receives gases from the ventilation chamber of the respective monoblock associated with the actuated seal, and the gases in the channel are exhausted from the exhaust vent extending therefrom.

15. The battery module system of claim 14, wherein the channel is a structural member configured for securing the one or more monoblocks.

16. The battery module system of claim 14, further comprising a baffle coupled to the channel, wherein the baffle is configured for securing the one or more monoblocks.

17. The battery module system of claim 14, further comprising a retainer for containing the one or more monoblocks, wherein the one or more monoblocks are in engagement with the retainer and the retainer includes connections for operation of the battery module system.

18. The battery module system of claim 14, wherein the cell retaining structure is configured to position and electrically connect the one or more cells to a retainer that supports the one or more monoblocks.

19. The battery module system of claim 14, wherein each ventilation chamber is configured such that a vent of each of the one or more cells is directed to an egress section in the ventilation chamber.

20. The battery module system of claim 14, wherein the seal between each ventilation chamber of the one or more monoblocks and the channel is independently actuatable when a threshold pressure is reached within the ventilation chamber or when a threshold temperature is reached within the ventilation chamber.
